(19) United States
(12) Patent Application Publication
(10) Pub. No.: US 2023/0135554 A1
(43) Pub. Date: May 4, 2023

(54) METHOD AND APPARATUS FOR MANAGING MOVEMENT IN AN INDOOR SPACE

(71) Applicant: HERE Global B.V., Eindhoven (NL)

(72) Inventors: Jerome BEAUREPAIRE, Berlin (DE); Eckhart KÖPPEN, Tampere (FI); Lauri Aarne Johannes WIROLA, Tampere (FI)

(21) Appl. No.: 17/516,202

(22) Filed: Nov. 1, 2021

(51) Int. Cl. G01C 21/34; H04W 4/021; H04W 4/33; G01C 21/20

(52) U.S. Cl. CPC G01C 21/3415; H04W 4/021; H04W 4/33; G01C 21/206; G01C 21/3492

(57) ABSTRACT

A method and system are disclosed for calculating a friction index for an indoor space to identify routing through the indoor space that avoids high friction regions, where friction is impedance to movement caused by obstructions. The system collects and processes data from sensors that detect attributes of obstructions and/or sensors that detect environmental conditions that indicate the presence of obstructions to calculate the friction index. Sensors can be location based or carried by persons. The system provides a navigation route that avoids high friction regions as an output.

### BACKGROUND

Service providers and device manufacturers (e.g., wireless, cellular, etc.) are continually challenged to deliver value and convenience to consumers by, for example, providing compelling network services and advancing underlying technologies. Increasing urban populations and scarcity of urban land have led to densely populated residential, business, and parking structures, especially in downtown areas of big cities around the world. Navigation through the indoor space of such densely populated structures is often impeded by obstructions, such as people, objects and/or vehicles, in the path of a person traveling between two points through the indoor space. Such obstructions on a desired path result in an individual having to reduce his/her pace, stop momentarily, and/or alter the desired path in order to avoid the obstructions. Such interruptions tend to cause stress to the individual, which may have follow on consequences in terms of safety and/or efficiency. It would be highly beneficial to reduce the stress of individuals traversing such indoor spaces by providing methods and apparatuses to aid in selection of a path where fewer obstructions and interruptions would be encountered.

### SOME EXAMPLE EMBODIMENTS

Therefore, there is a need for an approach for individuals to seamlessly navigate through indoor spaces over a route that minimizes slowdowns due to other people, objects, and/or vehicles.

According to one embodiment, a method for privacy-sensitive routing comprises receiving, by one or more processors, one or more of sensor data, path data, and infrastructure and usage data, associated with an indoor space. The method also comprises processing the one or more of sensor data, path data, and infrastructure and usage data to compute a friction index for the indoor space based on a distribution of the one or more obstructions, wherein friction is impedance to movement caused by one or more obstructions, and the friction index identifies one or more levels of friction, respectively, associated with one or more regions within the indoor space. The method further comprises generating a navigation route based on the friction index, wherein at least a portion of the navigation route traverses at least a portion of the indoor space.

According to another embodiment, an apparatus comprising at least one processor, and at least one memory including computer program code, the at least one memory and the computer program code configured to, with the at least one processor, cause the apparatus to receive, by one or more processors, one or more of sensor data, path data, and infrastructure and usage data, associated with an indoor space. The apparatus is also caused to process the one or more of sensor data, path data, and infrastructure and usage data to compute a friction index for the indoor space based on a distribution of the one or more obstructions, wherein friction is impedance to movement caused by one or more obstructions, and the friction index identifies one or more levels of friction, respectively, associated with one or more regions within the indoor space. The apparatus is further caused to generate a navigation route based on the friction index, wherein at least a portion of the navigation route traverses at least a portion of the indoor space.

According to another embodiment, a computer-readable storage medium carrying one or more sequences of one or more instructions which, when executed by one or more processors, cause an apparatus to receive, by one or more processors, one or more of sensor data, path data, and infrastructure and usage data, associated with an indoor space. The apparatus is also caused to process the one or more of sensor data, path data, and infrastructure and usage data to compute a friction index for the indoor space based on a distribution of the one or more obstructions, wherein friction is impedance to movement caused by one or more obstructions, and the friction index identifies one or more levels of friction, respectively, associated with one or more regions within the indoor space. The apparatus is further caused to generate a navigation route based on the friction index, wherein at least a portion of the navigation route traverses at least a portion of the indoor space.

According to another embodiment, an apparatus comprises means for receiving, by one or more processors, one or more of sensor data, path data, and infrastructure and usage data, associated with an indoor space. The apparatus also comprises means for processing the one or more of sensor data, path data, and infrastructure and usage data to compute a friction index for the indoor space based on a distribution of the one or more obstructions, wherein friction is impedance to movement caused by one or more obstructions, and the friction index identifies one or more levels of friction, respectively, associated with one or more regions within the indoor space. The apparatus further comprises means for generating a navigation route based on the friction index, wherein at least a portion of the navigation route traverses at least a portion of the indoor space.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of aiding navigation of an indoor space, according to one embodiment;

FIG. 2 is a diagram of the components of a system capable of aiding navigation of an indoor space, according to one embodiment;

FIG. 3 is a flowchart of a process for aiding navigation of an indoor space, according to one embodiment;

FIG. 4 is a diagram of user interfaces utilized in the processes of FIG. 3, according to various embodiments;

FIG. 5 is a diagram of a geographic database that can be used to implement an embodiment;

FIG. 6 is a diagram of hardware that can be used to implement an embodiment;

FIG. 7 is a diagram of a chip set that can be used to implement an embodiment; and

FIG. 8 is a diagram of a mobile station (e.g., handset) that can be used to implement an embodiment.

### DESCRIPTION OF PREFERRED EMBODIMENT

A method and apparatus for providing seamless navigation through indoor spaces over a route that minimizes slowdowns due to other people, objects, and/or vehicles are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein, the term “friction” refers to interruption to and/or slowing the progress of an individual traversing an indoor space, wherein such interruption and/or slowing is caused by obstructions, such as, but not limited to people, objects, and/or vehicles.

As used herein, the term “friction index” refers to an assessment of a particular indoor space at a particular time, wherein regions of high friction and low friction within the indoor spaced.

As used herein, the term “indoor space” refers to those portions of the interior of a structure, such as, but not limited to, an office building, a residential building, a sporting event or other entertainment venue, a shopping mall, or a transportation terminal (air, rail, bus, or the like), that are navigable by pedestrian traffic.

As used herein, the term “pedestrian traffic” can include individuals, walking, running, transporting an object such as a briefcase, suitcase, or other parcel, or operating a device to assist in ambulation, such as, but not limited to, a wheelchair or Segway™ device. assessment of a particular indoor space at a particular time, wherein regions of high friction and low friction within the indoor spaced.

As used herein, the term “seamless,” with respect to navigation and/or routing, refers a path wherein areas having higher levels of friction are avoided and/or areas having lower levels of friction are favored. Where a path through an indoor space is longer and/or the indoor space has a higher number of obstructions, the most seamless path would be the path cumulatively minimizes interaction with areas having higher levels of friction and/or cumulatively maximizes the interaction with areas having lower levels of friction.

As used herein, the term “navigation route,” refers to a path through an indoor space generated by the method disclosed herein, wherein the path so generated is a seamless path, or in other words, a path that avoids regions having a high friction level and favors regions having a low friction level.

As used herein, the term “circumventing path,” refers to a portion of a navigation route characterized by a deviation from an otherwise straight or substantially straight path (“primary path”) proximate to the circumventing path. An individual travelling along the primary path of a navigation route leaves the primary path and enters the circumventing path in order to avoid an obstruction on or near the primary path. In some embodiments, circumventing path comprises one or more curves to allow an individual following the navigation route to avoid an obstruction on or near the primary path. An individual travels along the primary path of a navigation route toward an obstruction on or near the primary path. Prior to reaching the obstruction, the individual leaves the primary path, enters the circumventing path to circumnavigate the obstruction, and then returns to the primary path in the downstream direction from the obstruction, such that the obstruction is behind the individual as they continue on the primary path. In some embodiments, a circumventing path can be a single curved segment connecting to the primary path upstream and downstream of an obstruction on or near the primary path. However, a circumventing path in other embodiments can be a connected series of curved and/or straight segments that allow and individual travelling along the navigation route to circumnavigate obstructions of various sizes and/or shapes.

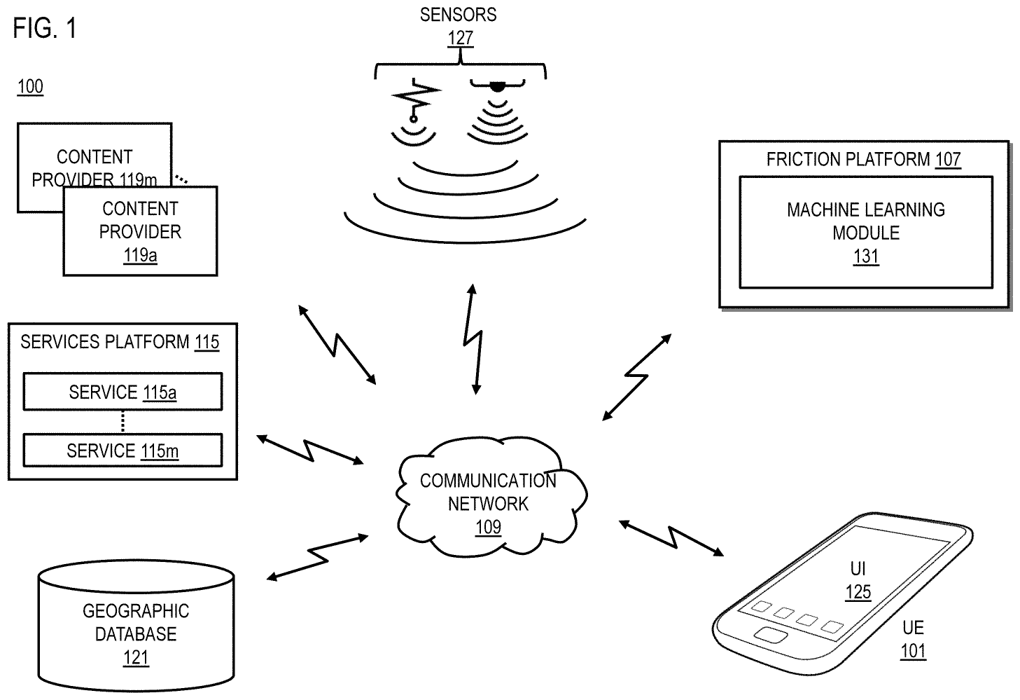

FIG. 1 is a diagram of a system capable of providing seamless navigation through indoor spaces over a route that minimizes slowdowns due to other people, objects, and/or vehicles are disclosed, according to one embodiment. Traversing distances in indoor spaces such as, but not limited to, densely populated office buildings, residential buildings, and/or parking structures, challenges the efficiency and aggravates the stress level of individuals forced to live and/or work in these situations on a regular basis. This can be an even greater challenge for occasional visitors to these crowded structures, such as, but not limited to family members or friends of workers or residents, businessmen from one business visiting the facilities of another business, service providers and repairmen (plumbers, electricians, janitorial personnel, and the like), and persons delivering mail and/or packages. These challenges to anyone desiring or needing to navigate these indoor spaces also increase in severity at certain times or during special events, such as, but not limited to: at the start or end of the work day, at lunch time, shift change, and/or during special events or meetings within or external to the structure.

The ability of people to navigate between office, residence, or parking space and entrance/exit or between two locations within a business, residential, or parking structure through the associated indoor spaces can be impeded and/or interrupted by obstructions such as, but not limited to: one or more people or groups of people; fixed obstructions such as columns or other structural features of a building; and/or movable obstructions such as stack of delivered boxes, janitorial equipment, mail delivery robots, carts delivering coffee and snacks, and/or parked or moving vehicles. It would be desirable for a person or a group of people to travel through an indoor space while eliminating or reducing the need to slow their pace, temporarily stop their progress, or cause them to alter their path due to obstructions on or near their path.

A system to facilitate navigation of indoor spaces with the goals of minimizing interruptions, delays, slowing of pace, and/or changing of path would desirably accomplish these goals while respecting the privacy of persons within the indoor space. In some embodiments, the system would anonymize data gathered from sensors associated with the existing infrastructure of a building or structure (e.g. cameras or sound monitors) would process those portions of the data required to detect the presence on one or more persons but would filter out portions of the data that would lead to identification of those one or more persons. In some embodiments, a system would collect and analyze data gather from sensors carried by one or more persons who frequent the indoor space as a function on their personal smart phone or sensors on wearable devices. Access to and privacy of sensor data collected by such “crowd sourcing” could be controlled by the persons carrying the sensors such that the level of privacy is controlled by their individual choices. Such crowd sourcing of sensor information would also provide information regarding the location of one or more persons without the need for adding infrastructure to the indoor space, such as, but not limited to, cameras or sound monitors. In some embodiments, the system includes access to indirect monitors of the presence of one or more persons such as, but not limited to, motion sensors, heat sensors, carbon-dioxide sensors, and/or any other sensor that gathers data of environmental attributes that indicate the presence of one or more persons without identifying those one or more persons.

To address this problem, a system 100 of FIG. 1 introduces the capability to receive, by one or more processors, one or more of sensor data, path data, and infrastructure and usage data, associated with an indoor space. The one or more of sensor data, path data, and infrastructure and usage data is processed to compute a friction index for the indoor space based on a distribution of the one or more obstructions, wherein friction is impedance to movement caused by one or more obstructions, and the friction index identifies one or more levels of friction, respectively, associated with one or more regions within the indoor space. System 100 generates one or more navigation routes based on the friction index, wherein at least a portion of the one or more navigation routes traverse at least a portion of the indoor space.

In some embodiments, system 100 collects crowd-sourced sensor data, retrieves sensor data from sensors of environmental conditions, and/or gathers anonymized sensor data from existing infrastructure, wherein the data gathered is useful for indicating the presence but not the identity. The system then analyzes the collected data to develop or calculate a friction index, which identifies regions or areas within the indoor space of high friction and low friction. The system then determines one or more routes through the indoor space that navigate away from areas of high friction and toward areas of low friction. In some embodiments, system 100 enables seamless indoor routing in a non-intrusive, privacy-sensitive manner without having to rely on development and/or use of existing infrastructure dedicated for this purpose.

One or more areas in an indoor space can be considered to have a high level of friction due to the presence of obstructions on a path through an indoor space. In some instances, an obstruction is formed by a high density of people and/or objects. For example, a group of six or more people standing in or moving slowly through a hallway while talking may effectively block a significant percentage of the width of the hallway, thus causing a choke point for other foot traffic moving at a faster pace. Another example would be tables and chairs in a cafeteria. Although, the cafeteria might be a large space, densely packed tables and chairs would greatly obstruct the progress of an individual trying to traverse the space of the cafeteria, and even more so if some of the chairs were occupied by people.

In some instances, is formed by a high number of people and/or objects. For example, a high number of individuals not in any particular grouping might be simultaneously traveling from their individual workspaces to a cafeteria for lunch or to an auditorium for a meeting. The individuals may not be densely packed and may even be spaced apart by a distance. The sheer number of people presents an obstruction to another individual traveling between two points in the indoor space by limiting the ability of that individual to either control or change pace or direction.

In some instances, the presence of new objects might require a detour to avoid the obstruction, such as a newly delivered stack of boxes holding office supplies or unattended or attended janitorial equipment. These new objects may act as independent obstructions or can act in combination with the already discussed high number and/or high density of persons and/or objects.

Other obstructions can be fixed as part of a building or structure, such as gated areas, transport modes with limited capacity like lifts, escalators, stairwells, doorways, doors, decorative or structural columns, to name a few. These can be independent obstructions or act in combination with already discussed new objects and/or high number and/or high density of persons and/or objects among other options.

In contrast, the absence of one or more of the foregoing obstructions would be indicia of a region or area of low friction or at least less friction. The level of friction associated with an area or region in an indoor space rests on the assessment of the degree to which an individual traveling on a selected path to a desired destination in the indoor space at a desired pace is required to slow from that desired pace and/or deviate from the selected path. The lowest friction would be exhibited by a region or area of an indoor space, which has no obstructions.

A navigation route, generated by system 100 based on the friction index, does not necessarily need to be highly accurate, the shortest route, or the fastest route. In some embodiments, system 100 can have user input parameters to tailor what a successful navigation route for a particular user. In general, though, an aspect of system 100 is to reduce the stress of the user induced by interruptions to and/or deviations from a path taken by a user between a point of origin and a destination in an indoor space. In another aspect, a navigation route determined by system 100 navigates a user away from high friction areas of the indoor space, as compared to a route through areas of higher friction, which would allow the user to think less about dealing with interruptions to their path of travel and more about a project at work or plans for the weekend. The end goal is to enable indoor routing without waiting or with minimized waiting moments. For example, a user is permitted to seamlessly leave an office at the end of the workday and exit the building without bumping into any, or at least as many, people and/or objects along the path to exit the building.

Another example is a businessman with a suitcase who would like to avoid the struggle of navigating through a crowd or be otherwise impeded by obstructions while transporting a large item. In this instance, system 100 can have a user input parameter to account for the suitcase, such that the navigation route generated for a user with a suitcase might be different than a navigation route generated for the user without the suitcase.

In one aspect, an objective of system 100 is to provide a seamless indoor routing experience to a given individual in need of or otherwise requesting such an experience. In another aspect, an objective of system 100 is to enable optimization of seamless indoor routing for a plurality of individuals.

In the context of the indoor space of a parking garage, in some embodiments, system 100 can aid in determining a more seamless route for a vehicle through avoiding high friction areas on the path from the entrance to an open parking space and/or from a parking space to the exit. Additionally, by accessing recent and longer-term historical data maintained by the operator of the parking garage, system 110 can further assist in avoidance of higher friction areas based on data such as, but not limited to, percentages and locations of occupied and vacant parking spaces and traffic and usage patterns in the parking garage at different times of the day and/or different days of the week. When multiple parking spaces are available, system 100 might process such data to select a parking space that facilitates an exit path that is predicted to better avoid areas of higher friction at a selected departure time.

### Data Collection

In some embodiments, sensor data for environmental attributes is gathered in a privacy-sensitive manner through measurement of environmental attributes that indicate the presence of one or more persons in the context of any indoor space and/or one or more vehicles in the context of a parking garage. In some embodiments, such data is independently processed to compute a friction index. In some embodiments, such data is processed in combination with one or more other sources of data (e.g. path data, sensor data for static and/or moving obstructions, infrastructure and usage data, or a combination thereof) to compute a friction index. Such environmental attributes include, but are not limited to, carbon-dioxide levels, temperature, sound levels, and/or carbon-monoxide. Sensors suited to measure each of these environmental attributes can be location-based, carried by individuals on their personal user devices (e.g. smart phones) or otherwise carried on their person (e.g. wearables), or a combination thereof. In some embodiments, system 100 collects data from multiple data sources (i.e. crowd-sourcing) such as, but not limited to, sensors collecting anonymized data available without the consent of any individuals, sensors in the possession of individuals to the extent such individuals have provided consent, or a combination thereof.

In indoor spaces in business and/or residential structures, temperature, carbon-dioxide levels, and/or sound levels increase in response to the presence of one or more persons and continue to increase as the number of persons increases. In open spaces in parking structures, temperature, carbon-dioxide levels, sound levels, and/or carbon-monoxide levels increase in response to the presence of one or more vehicles and continue to increase as the number of vehicles increases. In some embodiments, system 100 can implement algorithms to determine gradients of temperature, carbon-dioxide levels, sound levels, and/or carbon-monoxide levels that indicate or otherwise correspond to friction levels. Collection of such data related to environmental attributes is non-intrusive and does not impinge on the privacy rights of any individual.

In some embodiments, path data of one or more previously generated navigation routes is used to calculate a friction index of an indoor space. In some embodiments, such data is independently processed to compute a friction index. In some embodiments, such data is processed in combination with one or more other sources of data (e.g. sensor data for environmental attributes, sensor data for static and/or moving obstructions, infrastructure and usage data, or a combination thereof) to compute a friction index. Such path data may have been generated as recently as a minutes before or may comprise numerous paths generated during a selected time period. In some embodiments, path data to be processed can be filtered for relevance based on attributes such as point of origin, destination, time of day, or combinations thereof.

In some embodiments, path characteristics indicate presence of one or more new obstructions. In some embodiments, a plurality of previously generated navigation routes can indicate that users are circumventing an obstruction common to the one or more previously-generated navigation routes. The avoidance of such obstruction is indicated by a navigation route comprising a “circumventing path”, characterized by a straight path, followed curving of the path, followed by a return to the straight path. In some embodiments, the presence of a new obstruction is observed in one instance by detecting a circumventing path in an area of a newly-generated navigation route where a straight path is shown in the same area of one or more historical navigation routes. In some embodiments, the removal of a previous obstruction is observed in one instance by omitting a circumventing path in an area of a newly generated navigation route where a circumventing path is shown in the same area of one or more historical navigation routes. In some embodiments, historical path data, showing either the presence or absence of one or more circumventing paths, is accessed by system 100 with the consent of the user for which a historical navigation was generated, is collected by system 100 in an anonymized manner, or a combination thereof in order to not impinge on the privacy rights of any individual. In some embodiments, system 100 receives historical path data comprising one or more circumventing paths, wherein such circumventing paths indicate the presence of one or more of the obstructions. A friction index can be computed based only on the presence of the one or more obstructions as indicated by the one or more circumventing paths or can be computed based on the presence of the one or more obstructions indicated by the one or more circumventing paths in conjunction with system 100 processing sensor data, infrastructure data, usage data, or a combination thereof, received by system 100.

Historical path data can be selected from any desired timeframe and can be: recent, such as the same day; in the distant past, such as a year or more; or any time intermediate to those extremes. In one instance, a timeframe is selected to encompass a previous routine maintenance event in the indoor space of a building, wherein equipment associated with the maintenance event presents significant obstructions in a portion of the indoor space. Historical path data during the timeframe of such a maintenance event can include one or more circumventing paths to avoid the equipment associated with the maintenance event. In some embodiments, historical path data includes one or more navigation routes traveled by an individual as recorded by the UE 101 of the individual. In some embodiments, historical path data includes one or more navigation routes traveled by one or more other individuals as recorded by a UE associated with each of the one or more other individuals. In some embodiments, historical path data includes one or more navigation routes generated based on one or more previously calculated friction indexes for the indoor space.

In some embodiments, sensor data for static and/or moving obstructions is collected by system 100 from a motion sensor, a radar sensor, an infrared sensor, a vision-oriented sensor, such as digital video cameras (live or recorded), light detection and ranging (LIDAR) systems, an ultrasonic sensor, Bluetooth™ for relative positioning/density information, or a combination thereof are used to detect a number of persons exceeding a threshold number of persons moving at a pace below a threshold pace to calculate a friction level associated with the threshold number and threshold pace for the area in which the number of persons is located. In some embodiments, such data is independently processed to compute a friction index. In some embodiments, such data is processed in combination with one or more other sources of data (e.g. sensor data for environmental attributes, path data, infrastructure and usage data, or a combination thereof) to compute a friction index.

In some embodiments, infrastructure and usage data is collected by system 100 to calculate a friction index for and indoor space. In some embodiments, such data is independently processed to compute a friction index. In some embodiments, such data is processed in combination with one or more other sources of data (e.g. sensor data for environmental attributes, path data, sensor data for static and/or moving obstructions, or a combination thereof). In some embodiments, infrastructure and usage data is provided by third parties such as owners/operators of office buildings, residential buildings, and/or parking structures. Infrastructure data includes but is not limited to structural maps and dimensions of structural features associated with the indoor space to be traversed. Structural features can include, but are not limited to, rooms, hallways, stairways, elevators, doorways, doors, and other information about a structure useful for determining a capacity for holding persons and/or vehicles and for pedestrian and/or vehicle traffic of a potential navigation route through an indoor space of a structure. Usage data includes current and/or historical for the occupancy level of a structure and the number, location, and/or movement of persons and/or vehicles in or through the indoor space of an office building, residential building, and/or parking structure.

### System Outputs

In some embodiments, system 100 generate a “heat map” indicating areas of high and low friction accessible to a user by display on the user interface of user device. In one instance, an office worker preparing to leave the office can activate system 100 through a user device to view on the user interface display a heat map of the selected indoor space, wherein areas having various friction levels are color coded to allow the office worker to select a path that avoids areas having higher friction levels and includes areas having lower frictions levels. In some embodiments the user interface displays, either independently or in combination with the heat map, one or more proposed navigation routes to a desired location that avoids areas of higher friction.

In some embodiments, system 100 notifies a user, such as through a user device, of one or more times that would be favorable for seamless travel through an indoor space to a desired destination. In some embodiments, the user is provided the option to input one or more parameters, including, but not limited to, user-defined thresholds for acceptable levels of friction, preferred time-frame for travel (e.g., within an hour before or after close of business), destination of the trip, or a combination thereof. In one instance, an office worker signs up for daily text messages indicating when friction levels are relatively low in an office building, thereby indicating a preferred time to leave the office at the end of a workday, walk to the cafeteria, or the like. In some embodiments, friction levels of areas proximate to one or more routes commonly taken by an individual may be assessed and/or reported (e.g., path from office to building exit or cafeteria).

In some instances, a user of system 100 may not be a resident of a building but instead a delivery person, a service provider, or other visitor to the building. In one instance, a friction index is generated for a delivery person indicating friction levels of areas potentially on or near paths to a delivery/pickup location in a given building and/or the time that will be required to navigate to the destination. In the case where there are multiple deliveries within the building, system 100 can provide the most seamless navigation route for the multiple deliveries. In another instance, system 100 can optimize delivery/pickup routes for a plurality of target buildings based on the respective friction indexes associated with each building, respectively. In some embodiments, system 100 can further determine preferred delivery/pickup times, with the goal of avoiding/minimizing friction and/or wait times for delivery personnel.

### Learning/Predicting Friction

In some embodiments, once a friction index has been computed for an indoor space, system 100 trains a machine learning model that would learn which features and/or attributes are more likely to cause friction and to what level such friction would be caused. After determining and training a machine learning model for the key features and/or attributes of static and/or dynamic obstructions, based on processing one or more of sensor data, path data, and infrastructure and usage data, a trained machine learning model in system 100 could be used to predict friction indexes in other areas in a building where enough historical data might not be available or for buildings/areas that are not even built yet.

In some embodiments, a trained machine learning model of system 100 determines efficient methods to reduce the identified friction level of one or more areas in an indoor space. now that the key parameters would be identified and keep. In some embodiments, system 100 includes a feedback loop to monitor the effect of methods implemented to reduce the identified friction level of one or more areas in an indoor space.

In some embodiments, a machine learning module is trained by ground truth data over time to improve user experiences, based on maintaining predicted friction-related data and correlating to user feedback provided to system 100 by the user regarding whether use of one or more generated navigation routes were deemed successful by the user in terms of being sufficiently seamless. In some embodiments, user feedback provides sufficient information for training the machine learning model to provide weighting factors associated with different types of obstructions in order to improve the how reliably the method will predict a navigation route that suits the preferences of an individual user of the system.

In some embodiments, the methods and apparatuses disclosed herein a capable of including relevant outdoor spaces in a generated navigation route. In some instances, a point of origin can be in first and the destination can be in a second structure, wherein the first and second structures are spaced apart such that a navigation route would include a first portion in the indoor space of the first structure, a second portion in an outdoor space between the two structures, and a third portion in the indoor space of the second structure. The outdoor space might be traversed by methods including, but not limited to, walking, riding a bicycle, driving a car, or even using mass transportation such as a bus. In one instance, an individual user of the system disclosed herein is officed on a first building on the campus of a company having multiple buildings spaced apart on a large plot of land. The individual needs to attend a meeting being held in a second building. The distance between the buildings is such that the individual must: 1) traverse an indoor space in the first building, 2) traverse and outdoor space from the first building to a first parking garage, 3) traverse the indoor space of the first parking garage by walking from an entrance to the garage to a vehicle and then driving through the indoor space to an exit of the first garage, 4) traverse on outdoor space by driving from the first parking garage to a second parking garage, 5) traverse the indoor space of the second parking garage by driving from an entrance to a parking space and then walking from the parking space to the exit of the second parking garage, 6) traverse and outdoor space from the second parking garage to the second building, and 7) traverse the indoor space of the second building from an entrance to the location of the meeting. In this instance, a navigation route generated by the system disclosed herein would minimize the cumulative exposure to friction, meaning minimizing the interruptions to progress while either walking or driving over the navigation route, having seven segments as described above, wherein 4 segments were associated with traversing indoor spaces and 3 segments were associated with traversing outdoor spaces. Therefore, in some embodiments, the system disclosed herein facilitates generation of seamless navigation routes comprising at least one segment traversing and indoor space and at least one segment traversing an outdoor space.

As shown in FIG. 1, the system 100 comprises a user equipment (UE) 101 having connectivity to the friction platform 107, services platform 115, geographic database 121, sensors 127, and content providers 119 via the communication network 109. By way of example, the communication network 109 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), the Internet, or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), 5G New Radio networks, Long Term Evolution (LTE) networks, code division multiple access (CDMA), wireless fidelity (WiFi), satellite, mobile ad-hoc network (MANET), and the like.

The UE 101 is any type of mobile terminal, fixed terminal, or portable terminal including a mobile handset, station, unit, device, multimedia tablet, Internet node, communicator, desktop computer, laptop computer, Personal Digital Assistants (PDAs), or any combination thereof. It is also contemplated that the UE 101 can support any type of interface to the user (such as “wearable” circuitry, etc.).

A method for privacy-sensitive routing disclosed herein comprises receiving, by one or more processors, one or more of sensor data, path data, and infrastructure and usage data, associated with an indoor space. The one or more of sensor data, path data, and infrastructure and usage data are processed to compute a friction index for the indoor space based on a distribution of the one or more obstructions, wherein friction is impedance to movement caused by one or more obstructions, and the friction index identifies one or more levels of friction, respectively, associated with one or more regions within the indoor space. A navigation route is generated based on the friction index, wherein at least a portion of the navigation route traverses at least a portion of the indoor space. In some embodiments, the method further comprises identifying one or more attributes of the one or more obstructions producing friction, and training a machine learning model using the one or more attributes and the one or more obstructions. In some embodiments, the machine learning model predicts a friction index for a second indoor space. The navigation route is then provided as an output. In some of these embodiments:
a. the sensor data is collected from one or more sensors and indicates one or more obstructions to movement within the indoor space,
b. the path data is retrieved from one or more mobile devices and comprises one or more previously calculated friction indexes for the indoor space,
c. the infrastructure and usage data is obtained from one or more third parties and comprises infrastructure and usage data for the indoor space,
d. the infrastructure and usage data comprises occupancy levels for one or more of office spaces, living spaces, and parking spaces within the indoor space,
e. the navigation route comprises a starting point and an ending point, from which a route of minimum duration and a route of minimum distance are calculated based on an absence of obstructions, wherein at least a portion of the navigation route differs from the route of minimum duration or the route of minimum distance based on the portion being a greater distance from at least one region of the indoor space for which a level of friction was calculated than at least one of the route of minimum duration or the route of minimum distance,
f. the one or more sensors are location-based within the indoor space, carried on mobile devices within the indoor space, or a combination thereof,
g. the one or more sensors comprise one or more of a motion sensor, a radar sensor, infrared, an ultrasonic sensor, a vision-oriented sensor, such as digital video cameras, light detection and ranging (LIDAR) systems, a carbon-dioxide sensor, a carbon-monoxide sensor, a temperature sensor, a sound sensor, or a combination thereof, wherein the sensor data is processed to determine one or more gradients of data collected from one or more of the carbon-dioxide sensor, the carbon-monoxide sensor, the temperature sensor, the sound sensor, or a combination thereof, and the distribution of the one or more obstructions in the indoor space is determined based at least on the one or more gradients,
h. the one or more obstructions comprise one or more static map features, one or more dynamic elements, or a combination thereof, wherein the static map features comprise selected from one or more tables, one or more chairs, one or more desks, one or more structural features, one or more doorways, one or more doors, one or more transport modes, one or more stairways, or a combination thereof, and the dynamic elements comprise one or more persons, one or more vehicles, or a combination thereof,
i. the indoor space is located within a business structure, a residential structure, or a parking structure,
j. the one or more navigation routes provided as the output are characterized as having less friction that at least one alternative navigation route, and/or
k. the one or more navigation routes is suitable for use by an individual, a group of individuals, or an individual transporting one or more objects.

An apparatus for privacy-sensitive routing is disclosed herein. The apparatus comprises at least one processor and at least one memory. The at least one memory includes a computer program code for one or more programs. The at least one memory and the computer program code and the at least one processor are configured to cause the apparatus to receive, by one or more processors, one or more of sensor data, path data, and infrastructure and usage data, associated with an indoor space. The one or more of sensor data, path data, and infrastructure and usage data are processed to compute a friction index for the indoor space based on a distribution of the one or more obstructions, wherein friction is impedance to movement caused by one or more obstructions, and the friction index identifies one or more levels of friction, respectively, associated with one or more regions within the indoor space. A navigation route is generated based on the friction index, wherein at least a portion of the navigation route traverses at least a portion of the indoor space. In some embodiments, the apparatus is further caused to identify one or more attributes of the one or more obstructions producing friction and train a machine learning model using the one or more attributes and the one or more obstructions. In some embodiments, the machine learning model predicts a friction index for a second indoor space. The apparatus provides the navigation route as an output. In some of these embodiments:

a. the sensor data is collected from one or more sensors and indicates one or more obstructions to movement within the indoor space,
b. the path data is retrieved from one or more mobile devices and comprises one or more previously calculated friction indexes for the indoor space,
c. the infrastructure and usage data is obtained from one or more third parties and comprises infrastructure and usage data for the indoor space,
d. the infrastructure and usage data comprises occupancy levels for one or more of office spaces, living spaces, and parking spaces within the indoor space,
e. the navigation route comprises a starting point and an ending point, from which a route of minimum duration and a route of minimum distance are calculated based on an absence of obstructions, wherein at least a portion of the navigation route differs from the route of minimum duration or the route of minimum distance based on the portion being a greater distance from at least one region of the indoor space for which a level of friction was calculated than at least one of the route of minimum duration or the route of minimum distance,
f. the one or more sensors are location-based within the indoor space, carried on mobile devices within the indoor space, or a combination thereof,
g. the one or more sensors comprise one or more of a motion sensor, a radar sensor, infrared, an ultrasonic sensor, a vision-oriented sensor, such as digital video cameras, light detection and ranging (LIDAR) systems, a carbon-dioxide sensor, a carbon-monoxide sensor, a temperature sensor, a sound sensor, or a combination thereof, wherein the sensor data is processed to determine one or more gradients of data collected from one or more of the carbon-dioxide sensor, the carbon-monoxide sensor, the temperature sensor, the sound sensor, or a combination thereof, and the distribution of the one or more obstructions in the indoor space is determined based at least on the one or more gradients,
h. the one or more obstructions comprise one or more static map features, one or more dynamic elements, or a combination thereof, wherein the static map features comprise selected from one or more tables, one or more chairs, one or more desks, one or more structural features, one or more doorways, one or more doors, one or more transport modes, one or more stairways, or a combination thereof, and the dynamic elements comprise one or more persons, one or more vehicles, or a combination thereof,
i. the indoor space is located within a business structure, a residential structure, or a parking structure,
j. the one or more navigation routes provided as the output are characterized as having less friction that at least one alternative navigation route, and/or
k. the one or more navigation routes is suitable for use by an individual, a group of individuals, or an individual transporting one or more objects.

A non-transitory computer readable storage medium is disclosed herein. One or more program instructions are stored on the computer readable storage. The program instructions are executed by one or more processors to cause the apparatus for privacy-sensitive routing to at least receive, by one or more processors, one or more of sensor data, path data, and infrastructure and usage data, associated with an indoor space. The one or more of sensor data, path data, and infrastructure and usage data are processed to compute a friction index for the indoor space based on a distribution of the one or more obstructions, wherein friction is impedance to movement caused by one or more obstructions, and the friction index identifies one or more levels of friction, respectively, associated with one or more regions within the indoor space. A navigation route is generated based on the friction index, wherein at least a portion of the navigation route traverses at least a portion of the indoor space. In some embodiments, the apparatus is further caused to identify one or more attributes of the one or more obstructions producing friction, and train a machine learning model using the one or more attributes and the one or more obstructions. In some embodiments, the machine learning model predicts a friction index for a second indoor space. The apparatus is caused to provide the navigation route as an output. In some of these embodiments:
a. the sensor data is collected from one or more sensors and indicates one or more obstructions to movement within the indoor space,
b. the path data is retrieved from one or more mobile devices and comprises one or more previously calculated friction indexes for the indoor space,
c. the infrastructure and usage data is obtained from one or more third parties and comprises infrastructure and usage data for the indoor space,
d. the infrastructure and usage data comprises occupancy levels for one or more of office spaces, living spaces, and parking spaces within the indoor space,
e. the navigation route comprises a starting point and an ending point, from which a route of minimum duration and a route of minimum distance are calculated based on an absence of obstructions, wherein at least a portion of the navigation route differs from the route of minimum duration or the route of minimum distance based on the portion being a greater distance from at least one region of the indoor space for which a level of friction was calculated than at least one of the route of minimum duration or the route of minimum distance,
f. the one or more sensors are location-based within the indoor space, carried on mobile devices within the indoor space, or a combination thereof,
g. the one or more sensors comprise one or more of a motion sensor, a radar sensor, infrared, an ultrasonic sensor, a vision-oriented sensor, such as digital video cameras, light detection and ranging (LIDAR) systems, a carbon-dioxide sensor, a carbon-monoxide sensor, a temperature sensor, a sound sensor, or a combination thereof, wherein the sensor data is processed to determine one or more gradients of data collected from one or more of the carbon-dioxide sensor, the carbon-monoxide sensor, the temperature sensor, the sound sensor, or a combination thereof, and the distribution of the one or more obstructions in the indoor space is determined based at least on the one or more gradients,
h. the one or more obstructions comprise one or more static map features, one or more dynamic elements, or a combination thereof, wherein the static map features comprise selected from one or more tables, one or more chairs, one or more desks, one or more structural features, one or more doorways, one or more doors, one or more transport modes, one or more stairways, or a combination thereof, and the dynamic elements comprise one or more persons, one or more vehicles, or a combination thereof,
i. the indoor space is located within a business structure, a residential structure, or a parking structure,
j. the one or more navigation routes provided as the output are characterized as having less friction that at least one alternative navigation route, and/or
k. the one or more navigation routes is suitable for use by an individual, a group of individuals, or an individual transporting one or more objects.

By way of example, the UE 101, friction platform 107, services platform 115, geographic database 121, sensors 127, and content providers 119 communicate with each other and other components of the communication network 109 using well known, new or still developing protocols. In this context, a protocol includes a set of rules defining how the network nodes within the communication network 109 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In some embodiments, system 100 is provided with a UE 101 wherein an application is operable to produce UI 125 on UE 101 by installation of the application on UE 101, by access to application over communication network 109, or a combination thereof.

In some embodiments, system 100 receives, by one or more processors, one or more of sensor data, path data, and infrastructure and usage data, associated with an indoor space. Sensor data is collected by sensors 127. Sensors 127 include sensors that indirectly detect obstructions by sensing environmental attributes that indicate the presence of one or more obstructions, sensors that directly detect the attributes of obstructions, or a combination thereof. Sensors that detect environmental attributes include, but are not limited to, sensors that detect carbon-dioxide levels, temperature, sound levels, and/or carbon-monoxide. Sensors suited to measure each of these environmental attributes can be location-based, carried by individuals on their personal user devices (e.g. smart phones) or otherwise carried on their person (e.g. wearables), or a combination thereof. Sensors that directly detect attributes of static and dynamic obstructions include, but are not limited to one or more of a motion sensor, a radar sensor, an infrared sensor, a vision-oriented sensor, such as digital video cameras (live or recorded), light detection and ranging (LIDAR) systems, an ultrasonic sensor, Bluetooth™ for relative positioning/density information, or a combination thereof. Sensor data 127 is stored and/or processed by the friction platform 107.

Path data is a record of one or more navigation routes generated by the friction platform 107 and stored on the friction platform 107 and/or the geographic database 121. The record of each stored navigation route includes one or more of point of origin, destination, time of day, computed regions of friction and the level of friction associated with those regions, whether the navigation routes was actually used, and if so, a record of one or more parameters as assessed by the user to describe how successful the navigation route was in providing a seamless path from point of origin to destination. Any or all of these attributes of a stored navigation route can be designated as private by the user for whom the navigation route was generated, such that the attributes designated as private by such user are only available for access by that user and/or other users to whom that user has granted access rights. Path data is maintained on friction platform 107 and/or geographic database 121.

Infrastructure and usage data in this instance is maintained by third parties, such as an owner/operator of a business structure, a residential structure, or a parking structure. Infrastructure data includes all mapping and dimensional information a structure that is useful for determining the capacity for and/or limitations to pedestrian traffic through the indoor space of the structure and that can be made available to system 100. Usage data includes all aspects of the occupancy level of the indoor space of a structure by persons and/or vehicles, including location of persons and/or vehicles at different times of days and different days of the week along with the time and pace of the movement of such persons and/or vehicles through the indoor space of the structure at any selected time and that can be made available to system 100. In this instance, infrastructure and usage data is available from content providers 119a-119m.

Friction platform 107 processes one or more of sensor data, path data, and obstruction data and computes a friction index for an indoor space based on a distribution of one or more static and/or dynamic obstructions. Friction is impedance to movement caused by one or more obstructions. The friction index identifies one or more regions within the indoor space and levels of frictions associated with each of those regions respectively. A navigation route is generated by friction platform 107 based on the computed friction index and sent to UE 101 and interactively displayed for the user on user interface (UI) 125.

One of more of sensor data, path data, and infrastructure and usage data is used to train machine learning module 131 to extend use of system 100 for prediction of friction indexes for parts of a structure for which historical data is limited and/or for structures that have not been built yet.

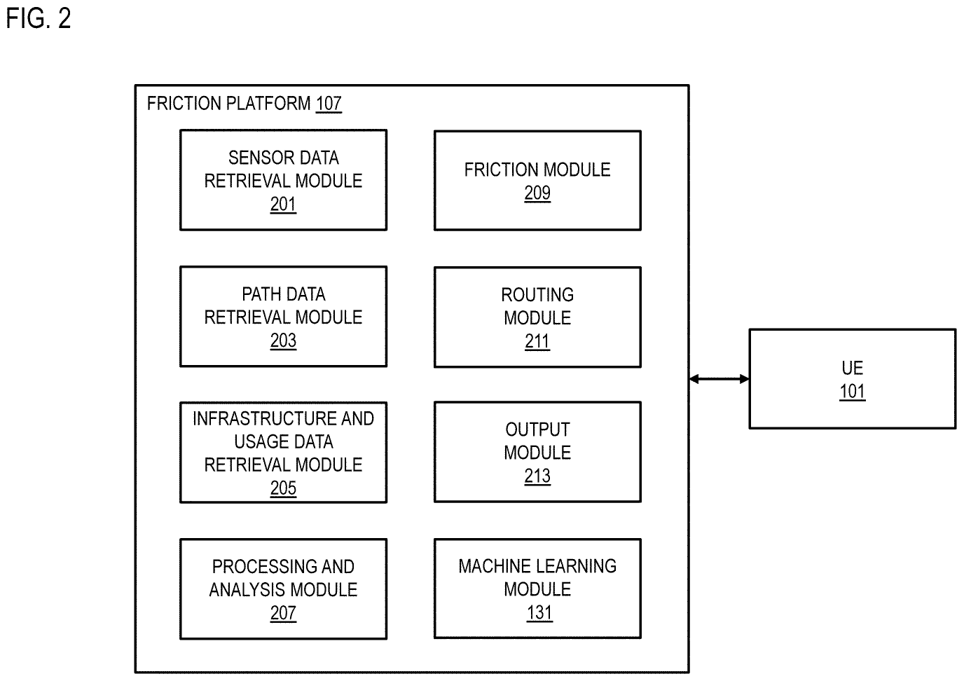

FIG. 2 is a diagram of the components of the friction platform 107, according to one embodiment. By way of example, the friction platform includes one or more components for providing seamless navigation through indoor spaces over a route that minimizes slowdowns due to other people, objects, and/or vehicles. The method and apparatus receives sensor data, path data, and/or infrastructure and usage data, associated with an indoor space, using sensor data retrieval module 201, path data retrieval module 203, and infrastructure and usage data retrieval module 205, respectively. The data received is processed in processing and analysis module 207 and a friction index for the indoor space based on a distribution of the one or more obstructions is calculated by friction module 209. The routing module 211 generates of navigation route based on the friction index. Output module 213 sends the navigation route to UE 101 for display on UI 125. Machine learning module 131 is trained based on historical navigation routes to predict friction indexes for indoor spaces lacking historical data.

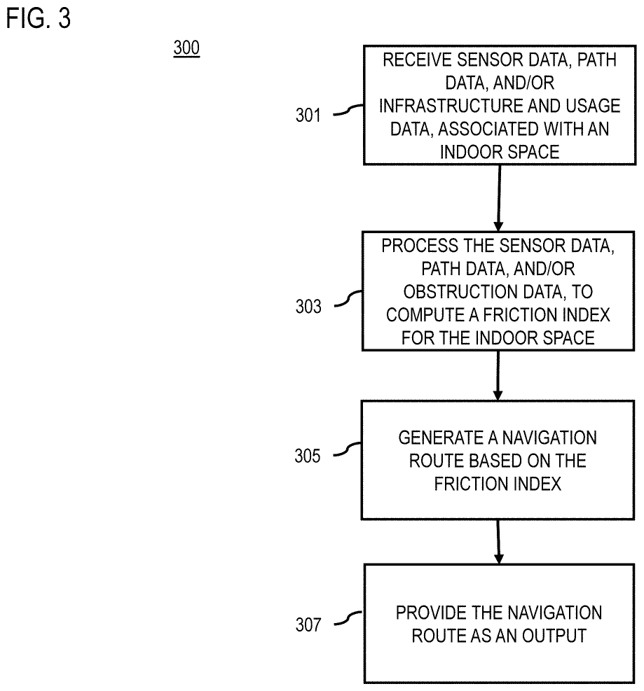

It is contemplated that the functions of these components may be combined in one or more components or performed by other components of equivalent functionality. In this embodiment, the friction platform 107 includes a sensor data retrieval module 201, a path data retrieval module 203, an infrastructure and usage data retrieval module 205, a processing and analysis module 207, a friction module 209, a routing module 211, an output module 213, and machine learning module 131 and has connectivity to UE 101. The above presented modules and components of the friction platform 107 can be implemented in hardware, firmware, software, or a combination thereof. Though depicted as a separate entity in FIG. 1, it is contemplated that the friction platform 107 may be implemented as a module of any other component of the system 100. In another embodiment, the friction platform 107 and/or the modules 201-213 and 131 may be implemented as a cloud-based service, local service, native application, or combination thereof. The functions of the friction platform 107 and/or the modules 201-213 and 131 are discussed with respect to FIG. 3.

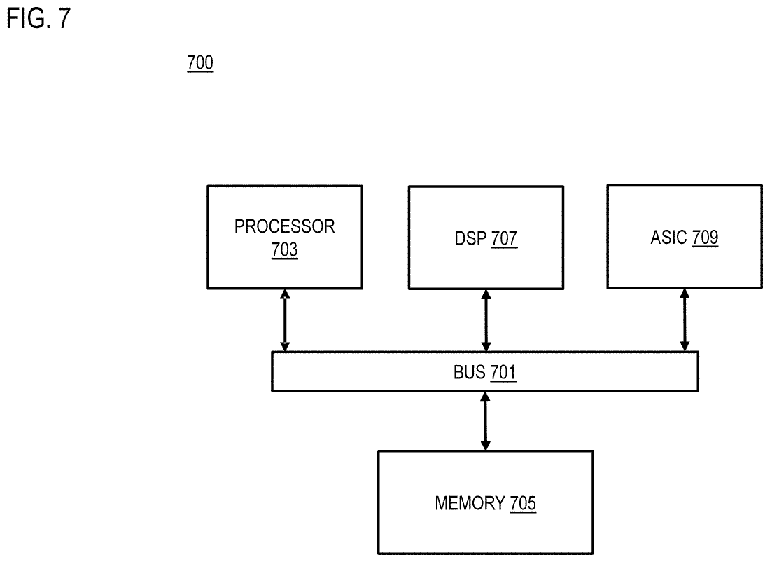

FIG. 3 is a flowchart of a process for providing seamless navigation through indoor spaces over a route that minimizes slowdowns due to other people, objects, and/or vehicles, according to one embodiment. In various embodiments, the friction platform 107, the machine learning module 131, and/or any of the modules 201-213 may perform one or more portions of the process 300 and may be implemented in, for instance, a chip set including a processor and a memory as shown in FIG. 7. As such, the friction platform 107, the machine learning module 131, and/or the modules 201-213 can provide means for accomplishing various parts of the process 300, as well as means for accomplishing embodiments of other processes described herein in conjunction with other components of the system 100. Although the process 300 is illustrated and described as a sequence of steps, its contemplated that various embodiments of the process 300 may be performed in any order or combination and need not include all the illustrated steps.

In step 301, the sensor data retrieval module 201 receives sensor data from sensors 127 through communication network 109, the path data retrieval module 203 receives path data from friction platform 107, geographic database 121, and/or one or more mobile devices through communication network 109, and/or the infrastructure and usage data retrieval module 205 receives infrastructure and usage data through communication network 109.

In step 303, received data is processed to detect the presence of one or more fixed and/or dynamic obstructions along with the distribution of such obstructions in the indoor space through which a navigation route is to be determined. Based on the distribution of the one or more obstructions in the indoor space to be traversed, friction module 209 computes a friction index for the indoor space. The friction index identifies one or more levels of friction, respectively, associated with one or more regions within the indoor space.

In step 305, the routing module 211 generates a navigation route based on the friction index, wherein the navigation route avoids areas having high friction levels and prioritizes areas having low friction levels.

In step 307, the output module 213 sends the navigation route to UE 101 for display on UI 125. In one instance, an individual in his fifth floor office desires to leave work at 4 p.m., the normal end of the workday at his place of employment. He engages system 100 to generate a navigation route to his vehicle on the third floor of a multi-level parking structure separated from but adjacent to the office building.

System 100 initially displays a map of the third floor wherein a navigation route is highlighted. The navigation route follows a back hallway to a stairwell. Even though the back hallway is smaller and a greater distance to the stairwell than the main hallway leading to the elevator, system 100 identifies areas of high friction in parts of the main hallway and at the elevator, based in part on current sensor data and based in part on historical pedestrian traffic patterns at 4 p.m. on normal workdays. The employee walks farther to the stairwell but experiences no interruptions due to obstructions on his way to the stairwell. The map display includes instruction to follow the stairwell to a basement level.

Upon exiting the stairwell on the basement level, system 100 updates UI 125 to show a map of the tunnel system interconnecting buildings in the local area. A tunnel path to one of three entrances to the parking structure is highlighted on the map. The path through the tunnel avoids crowds and other ground level obstructions.

At this juncture, UE 125 directs the individual to enter another stairwell to travel to the third floor of the parking structure. Upon exiting the stairwell on the third floor of the parking structure, UE 125 is again updated to show a map of third level parking. Based in part on current sensor data and based in part on historical pedestrian traffic patterns and vehicle traffic patterns at 4 p.m. on normal workdays, the map of third level parking included a highlighted path to the individual's vehicle. Again, system 100 selected a navigation route minimizing the individual's exposure to crowds and vehicle traffic, resulting in a longer walking path but with fewer interruptions.

In some embodiments, system 100 can be configured by use-defined parameters in order to personalize a generated navigation route. In one instance of the foregoing example, a user can define an acceptable time interval for departure, in which case system 100 might display a recommended delay in departure time in order to reduce exposure of the user to interruptions to his travel to his vehicle due to crowds and/or vehicle traffic. In another instance of the foregoing example, a user can specify to avoid stairwells. Although this limitation produces more exposure to interruptions due to crowds, some individuals would prefer some amount of interruptions in order to avoid stairs. The above time and stairwell parameters might be used alone or in combination with each other or any number of other user-defined parameters.

In some embodiments, the user could configure engagement of other services by system 100. For instance, system 100 could be configured to provide weather alerts for an individual to leave work early if stormy weather is predicted.

In some embodiments, machine learning module 131 is trained based on historical navigation routes to predict friction indexes for indoor spaces lacking historical data. and machine learning module 131 and has connectivity to UE 101 for display on UI 125.

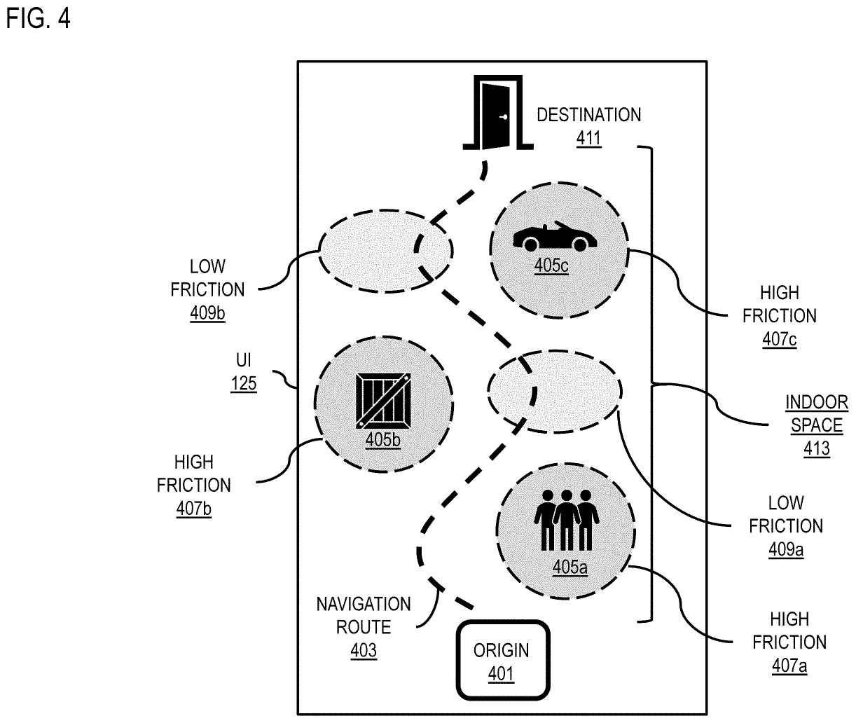

FIG. 4 is a diagram of a user interface utilized in the processes of FIG. 3, according to various embodiments. The diagram in FIG. 4 is a simplified cartoon representation of UI 125 in order to comply with rules related to drawings included in patent applications. In some embodiments, an actual display on UI 125 of UE 101 would provide attributes such as, but not limited to, high resolution, detailed coloring, and user interaction with a touch-screen display such as, but not limited to zoom and up-down, left-right navigation of the display, all of which are common on current navigation applications.

In some embodiments, point for origin 401 can be input by the user or can be detected by the global positioning system (GPS) of UE 101. System 100 provides a common method for the user to interact with UI 125 to input destination 411. Based on the point of origin 401 and destination 411, the infrastructure and usage data retrieval module 205 would collect information about the structure, which the user desires to navigate, to determine the applicable boundaries of indoor space 413. In some embodiments, infrastructure and usage data retrieval module 205 would further collect information about the occupancy of the structure as an indicator or the possibility, number, and/or distribution of dynamic obstructions (i.e. people) . . . structure, which the user desires to navigate, to determine the applicable for which system 100 will process sensor data, path data, infrastructure data, usage data, or any combination thereof processing the sensor data, path data, infrastructure data, usage data, as available, to compute a friction index for the indoor space based on the distribution of obstructions 405a, 405b, 405c. Friction related to obstructions 405a (people), 405c (vehicles) can be derived indirectly if sensor data of environmental attributes that indicate the presence of one or more obstructions is available and/or directly if sensor data of attributes of obstructions is available. Friction related to obstruction 405b (box) can more effectively be derived directly if sensor data of attributes of obstructions is available. Friction module 209 calculates friction associated with these obstructions and generates a friction index, identifying regions of high friction 407a, 407b, 407c and regions of low friction 409a, 409b within indoor space 413. Routing module 211 and output module 213 generate navigation route 403 based on the friction index.

In one instance, in step 301, sensor data retrieval module 201 receives sensor data from sensors 127, path data retrieval module 203 receives path data from routing module 211 and or geographic database 121, and/or infrastructure and usage data retrieval module 205 receives infrastructure data associated with the portion of the structure associated with indoor space 413 and/or usage data associated with the portion of the structure associated with indoor space 413.

In step 303, data received by sensor data retrieval module 201, path data retrieval module 203, and/or infrastructure and usage data retrieval module 205 is processed by processing and analysis module 207 to determine one or more obstructions within indoor space 413. In the instance shown in FIG. 4, processing and analysis module 207 has identified obstruction 405a (a group of persons), obstruction 405b (a shipping box), and obstruction 405c (a vehicle). Processing and analysis module 207 further identifies a region 407a associated with obstruction 405a, wherein region 407a is determined to have a high level of friction resulting in an impediment to pedestrian traffic in region 407a. Processing and analysis module 207 further identifies a region 407b associated with obstruction 405b, wherein region 407b is determined to have a high level of friction resulting in an impediment to pedestrian traffic in region 407b. Processing and analysis module 207 further identifies a region 407c associated with obstruction 405c, wherein region 407c is determined to have a high level of friction resulting in an impediment to pedestrian traffic in region 407c. Processing and analysis module 207 further identifies a regions 409a and 409b associated with obstructions (not shown in order to simplify diagram) which are determined to have a low level of friction. Processing and analysis module 207 computes a friction index for indoor space 405 comprising regions 407a, 407b, 407c, 409a, and 409b, along with their respective levels of friction, which translates to their respective negative impact on the free flow of pedestrian traffic.

In step 305, routing module 211 generates navigation route 403, which is the path between point of origin 401 and destination 411 through indoor space 413, which has exposes the user requesting navigation route 403 to the minimum cumulative friction from obstructions in regions 407a, 407b, 407c, 409a, and 409b, as compared to all other available paths between point of origin 401 and destination 411 through indoor space 413. Navigation route 403 is shown to avoid high friction regions 407a, 407b, and 407c. Navigation route 403 is shown to pass through regions 409a and 409b, indicating that, in this example, not all obstructions presenting an impediment to pedestrian traffic could be avoided by any available path between point of origin 401 and destination 411 through indoor space 413. The portion of navigation route 403 not passing through regions 409a and 409b indicates portions of the path where no friction is present other than that which is present due to the infrastructure of the building and cannot be eliminated by selection of another path through indoor space 413 between point of origin 401 and destination 411.

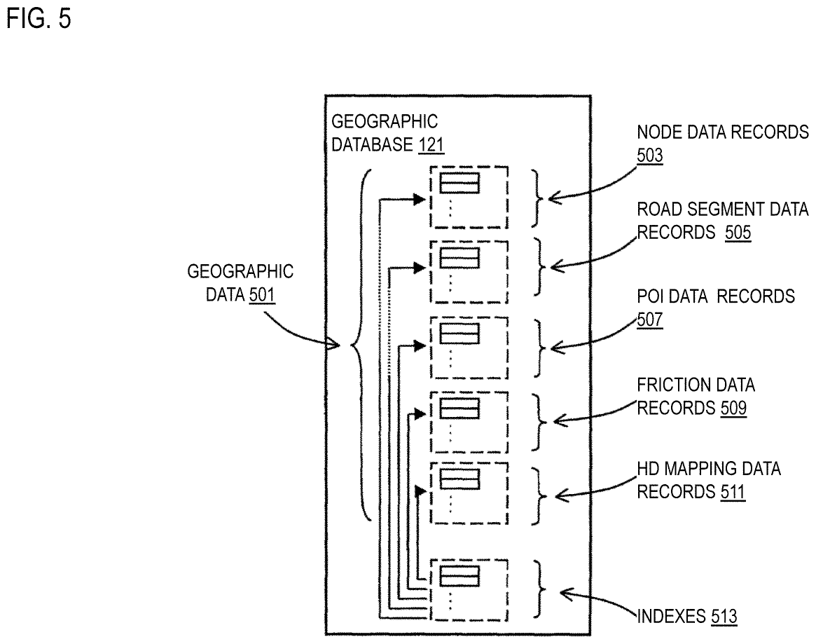

FIG. 5 is a diagram of a geographic database (such as the database 121), according to one embodiment. In one embodiment, the geographic database 121 includes geographic data 501 used for (or configured to be compiled to be used for) mapping and/or navigation-related services, such as for video odometry based on the parametric representation of lanes include, e.g., encoding and/or decoding parametric representations into lane lines. In one embodiment, the geographic database 121 include high resolution or high definition (HD) mapping data that provide centimeter-level or better accuracy of map features. For example, the geographic database 121 can be based on Light Detection and Ranging (LiDAR) or equivalent technology to collect billions of 3D points and model road surfaces and other map features down to the number lanes and their widths. In one embodiment, the HD mapping data (e.g., HD data records 511) capture and store details such as the slope and curvature of the road, lane markings, roadside objects such as signposts, including what the signage denotes. By way of example, the HD mapping data enable highly automated vehicles to precisely localize themselves on the road.

In one embodiment, geographic features (e.g., two-dimensional, or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions. Accordingly, the terms polygons and polygon extrusions as used herein can be used interchangeably.

In one embodiment, the following terminology applies to the representation of geographic features in the geographic database 121.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alert a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 121 follows certain conventions. For example, links do not cross themselves and do not cross each other except at a node. Also, there are no duplicated shape points, nodes, or links. Two links that connect each other have a common node. In the geographic database 121, overlapping geographic features are represented by overlapping polygons. When polygons overlap, the boundary of one polygon crosses the boundary of the other polygon. In the geographic database 121, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 121 includes node data records 503, road segment or link data records 505, POI data records 507, friction data records 509, HD mapping data records 511, and indexes 513, for example. More, fewer, or different data records can be provided. In one embodiment, additional data records (not shown) can include cartographic (“carto”) data records, routing data, and maneuver data. In one embodiment, the indexes 513 may improve the speed of data retrieval operations in the geographic database 121. In one embodiment, the indexes 513 may be used to quickly locate data without having to search every row in the geographic database 121 every time it is accessed. For example, in one embodiment, the indexes 513 can be a spatial index of the polygon points associated with stored feature polygons.

In exemplary embodiments, the road segment data records 505 are links or segments representing roads, streets, or paths, as can be used in the calculated route or recorded route information for determination of one or more personalized routes. The node data records 503 are end points (such as representing intersections, respectively) corresponding to the respective links or segments of the road segment data records 505. The road link data records 505 and the node data records 503 represent a road network, such as used by vehicles, cars, and/or other entities. Alternatively, the geographic database 121 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 121 can include data about the POIs and their respective locations in the POI data records 507. The geographic database 121 can also include data about places, such as cities, towns, or other communities, and other geographic features, such as bodies of water, mountain ranges, etc. Such place or feature data can be part of the POI data records 507 or can be associated with POIs or POI data records 507 (such as a data point used for displaying or representing a position of a city).

In some embodiments, in the context of an indoor space, the link segments and nodes can be associated with attributes, such as geographic coordinates, floor of a building, room/office numbers, sensor data obstruction data, path data, infrastructure and usage data, and other navigation related attributes, as well as POIs, such as, but not limited to, cafeterias, restrooms, conference rooms, entrances, exits, stairwells, elevators, etc. The geographic database 121 can include data about the POIs and their respective locations in the POI data records 507. The geographic database 121 can also include data about places, such as cities, towns, or other communities, and other geographic features, such as bodies of water, mountain ranges, etc. Such place or feature data can be part of the POI data records 507 or can be associated with POIs or POI data records 507 (such as a data point used for displaying or representing a position of a city).

In one embodiment, the geographic database 121 can also include friction data records 509 for storing information related to seamless navigation through an indoor space over a route that minimizes slowdowns due to other people, objects, and/or vehicles, such as, but not limited to sensor data, path data, infrastructure and usage data, obstruction data, and/or friction indexes, or used by the system 100 according to the various embodiments described herein. By way of example, the friction data records 509 can be associated with one or more of the node records 503, road segment records 505, and/or POI data records 507 to support seamless navigation through an indoor space over a route that minimizes slowdowns due to other people, objects, and/or vehicles. In this way, the friction data records 509 can also be associated with or used to classify the characteristics or metadata of the corresponding records 503, 505, and/or 507.

In one embodiment, as discussed above, the HD mapping data records 511 model road surfaces and other map features to centimeter-level or better accuracy. The HD mapping data records 511 also include lane models that provide the precise lane geometry with lane boundaries, as well as rich attributes of the lane models. These rich attributes include, but are not limited to, lane traversal information, lane types, lane marking types, lane level speed limit information, and/or the like. In one embodiment, the HD mapping data records 511 are divided into spatial partitions of varying sizes to provide HD mapping data to vehicles and other end user devices with near real-time speed without overloading the available resources of the vehicles and/or devices (e.g., computational, memory, bandwidth, etc. resources).

In one embodiment, the HD mapping data records 511 are created from high-resolution 3D mesh or point-cloud data generated, for instance, from LiDAR-equipped vehicles. The 3D mesh or point-cloud data are processed to create 3D representations of a street or geographic environment at centimeter-level accuracy for storage in the HD mapping data records 511.

In one embodiment, the HD mapping data records 511 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time also at centimeter-level accuracy. Other sensor data can include vehicle telemetry or operational data such as windshield wiper activation state, braking state, steering angle, accelerator position, and/or the like.

In one embodiment, the geographic database 121 can be maintained by the content provider 119 in association with the services platform 115 (e.g., a map developer). The map developer can collect geographic data to generate and enhance the geographic database 121. There can be different ways used by the map developer to collect data. These ways can include obtaining data from other sources, such as municipalities or respective geographic authorities. In addition, the map developer can employ field personnel to travel by vehicle (e.g., vehicles and/or UEs 101) along roads throughout the geographic region to observe features and/or record information about them, for example. Also, remote sensing, such as aerial or satellite photography, can be used.

The geographic database 121 can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle or a UE 101, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for providing seamless navigation through an indoor space over a route that minimizes slowdowns due to other people, objects, and/or vehicles may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

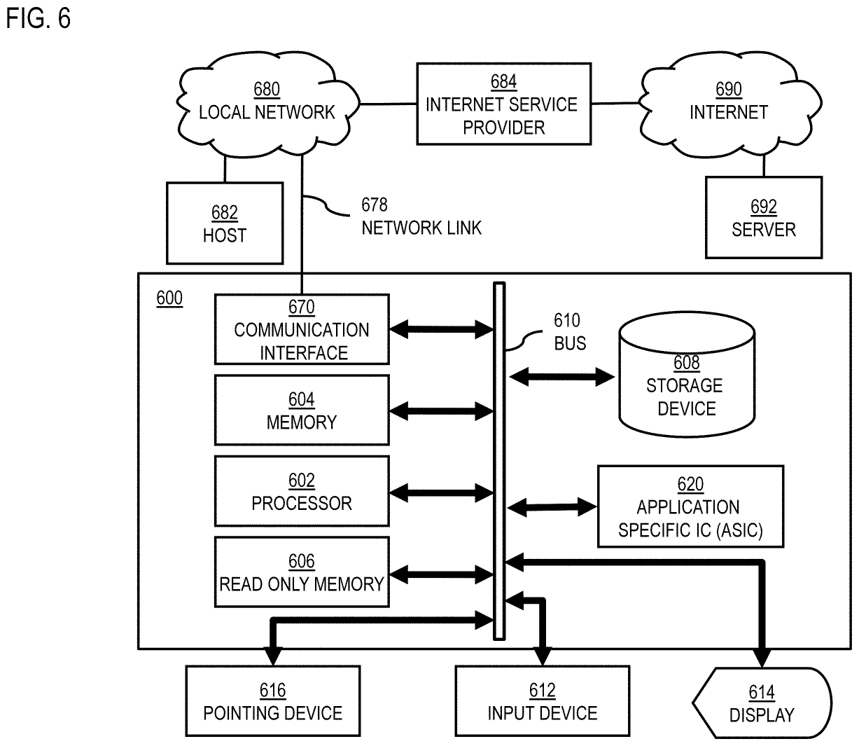

FIG. 6 illustrates a computer system 600 upon which an embodiment of the invention may be implemented. Computer system 600 is programmed (e.g., via computer program code or instructions) to seamlessly navigate through an indoor space over a route that minimizes slowdowns due to other people, objects, and/or vehicles, as described herein and includes a communication mechanism such as a bus 610 for passing information between other internal and external components of the computer system 600. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 610 includes one or more parallel conductors of information so that information is transferred quickly among devices coupled to the bus 610. One or more processors 602 for processing information are coupled with the bus 610.

A processor 602 performs a set of operations on information as specified by computer program code related to seamlessly navigate through an indoor space over a route that minimizes slowdowns due to other people, objects, and/or vehicles. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 610 and placing information on the bus 610. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 602, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 600 also includes a memory 604 coupled to bus 610. The memory 604, such as a random access memory (RAM) or other dynamic storage device, stores information including processor instructions for seamless navigation through an indoor space over a route that minimizes slowdowns due to other people, objects, and/or vehicles. Dynamic memory allows information stored therein to be changed by the computer system 600. RAM allows a unit of information stored at a location called a memory address to be stored and retrieved independently of information at neighboring addresses. The memory 604 is also used by the processor 602 to store temporary values during execution of processor instructions. The computer system 600 also includes a read only memory (ROM) 606 or other static storage device coupled to the bus 610 for storing static information, including instructions, that is not changed by the computer system 600. Some memory is composed of volatile storage that loses the information stored thereon when power is lost. Also coupled to bus 610 is a non-volatile (persistent) storage device 608, such as a magnetic disk, optical disk or flash card, for storing information, including instructions, that persists even when the computer system 600 is turned off or otherwise loses power.

Information, including instructions for seamless navigation through an indoor space over a route that minimizes slowdowns due to other people, objects, and/or vehicles, is provided to the bus 610 for use by the processor from an external input device 612, such as a keyboard containing alphanumeric keys operated by a human user, or a sensor. A sensor detects conditions in its vicinity and transforms those detections into physical expression compatible with the measurable phenomenon used to represent information in computer system 600. Other external devices coupled to bus 610, used primarily for interacting with humans, include a display device 614, such as a cathode ray tube (CRT) or a liquid crystal display (LCD), or plasma screen or printer for presenting text or images, and a pointing device 616, such as a mouse or a trackball or cursor direction keys, or motion sensor, for controlling a position of a small cursor image presented on the display 614 and issuing commands associated with graphical elements presented on the display 614. In some embodiments, for example, in embodiments in which the computer system 600 performs all functions automatically without human input, one or more of external input device 612, display device 614 and pointing device 616 is omitted.

In the illustrated embodiment, special purpose hardware, such as an application specific integrated circuit (ASIC) 620, is coupled to bus 610. The special purpose hardware is configured to perform operations not performed by processor 602 quickly enough for special purposes. Examples of application specific ICs include graphics accelerator cards for generating images for display 614, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 600 also includes one or more instances of a communications interface 670 coupled to bus 610. Communication interface 670 provides a one-way or two-way communication coupling to a variety of external devices that operate with their own processors, such as printers, scanners and external disks. In general the coupling is with a network link 678 that is connected to a local network 680 to which a variety of external devices with their own processors are connected. For example, communication interface 670 may be a parallel port or a serial port or a universal serial bus (USB) port on a personal computer. In some embodiments, communications interface 670 is an integrated services digital network (ISDN) card or a digital subscriber line (DSL) card or a telephone modem that provides an information communication connection to a corresponding type of telephone line. In some embodiments, a communication interface 670 is a cable modem that converts signals on bus 610 into signals for a communication connection over a coaxial cable or into optical signals for a communication connection over a fiber optic cable. As another example, communications interface 670 may be a local area network (LAN) card to provide a data communication connection to a compatible LAN, such as Ethernet. Wireless links may also be implemented. For wireless links, the communications interface 670 sends or receives or both sends and receives electrical, acoustic or electromagnetic signals, including infrared and optical signals, that carry information streams, such as digital data. For example, in wireless handheld devices, such as mobile telephones like cell phones, the communications interface 670 includes a radio band electromagnetic transmitter and receiver called a radio transceiver. In certain embodiments, the communications interface 670 enables connection to the communication network 109 for seamless navigation through an indoor space over a route that minimizes slowdowns due to other people, objects, and/or vehicles to the UE 101.

The term computer-readable medium is used herein to refer to any medium that participates in providing information to processor 602, including instructions for execution. Such a medium may take many forms, including, but not limited to, non-volatile media, volatile media and transmission media. Non-volatile media include, for example, optical or magnetic disks, such as storage device 608. Volatile media include, for example, dynamic memory 604. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 678 typically provides information communication using transmission media through one or more networks to other devices that use or process the information. For example, network link 678 may provide a connection through local network 680 to a host computer 682 or to equipment 684 operated by an Internet Service Provider (ISP). ISP equipment 684 in turn provides data communication services through the public, world-wide packet-switching communication network of networks now commonly referred to as the Internet 690.

A computer called a server host 692 connected to the Internet hosts a process that provides a service in response to information received over the Internet. For example, server host 692 hosts a process that provides information representing video data for presentation at display 614. It is contemplated that the components of system can be deployed in various configurations within other computer systems, e.g., host 682 and server 692.

FIG. 7 illustrates a chip set 700 upon which an embodiment of the invention may be implemented. Chip set 700 is programmed to seamlessly navigate through an indoor space over a route that minimizes slowdowns due to other people, objects, and/or vehicles, as described herein and includes, for instance, the processor and memory components described with respect to FIG. 6 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively, or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-world signals (e.g., sound) in real time independently of the processor 703. Similarly, an ASIC 709 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 703 and accompanying components have connectivity to the memory 705 via the bus 701. The memory 705 includes both dynamic memory (e.g., RAM, magnetic disk, writable optical disk, etc.) and static memory (e.g., ROM, CD-ROM, etc.) for storing executable instructions that when executed perform the inventive steps described herein to seamlessly navigate through an indoor space over a route that minimizes slowdowns due to other people, objects, and/or vehicles. The memory 705 also stores the data associated with or generated by the execution of the inventive steps.

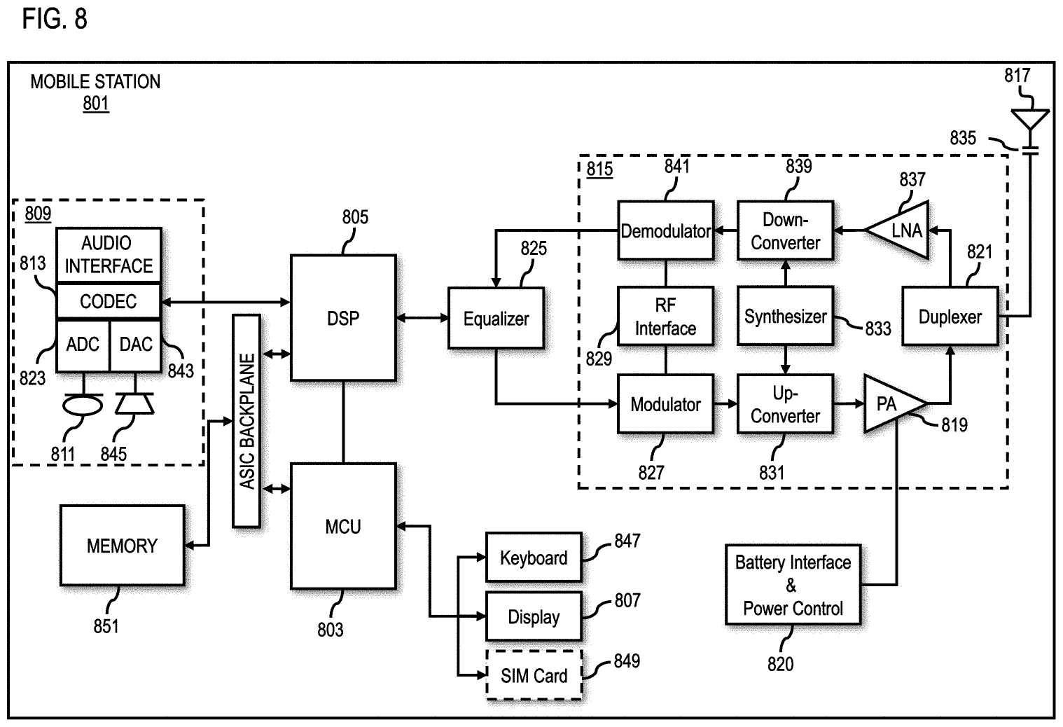

FIG. 8 is a diagram of exemplary components of a mobile terminal (e.g., handset) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile station functions that offer automatic contact matching. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system, via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile station 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, 5G New Radio networks, code division multiple access (CDMA), wireless fidelity (WiFi), satellite, and the like.

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 805. A Digital to Analog Converter (DAC) 843 converts the signal and the resulting output is transmitted to the user through the speaker 845, all under control of a Main Control Unit (MCU) 803—which can be implemented as a Central Processing Unit (CPU) (not shown).

The MCU 803 receives various signals including input signals from the keyboard 847. The keyboard 847 and/or the MCU 803 in combination with other user input components (e.g., the microphone 811) comprise a user interface circuitry for managing user input. The MCU 803 runs a user interface software to facilitate user control of at least some functions of the mobile station 801 to seamlessly navigate through an indoor space over a route that minimizes slowdowns due to other people, objects, and/or vehicles. The MCU 803 also delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the station. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile station 801.

The CODEC 813 includes the ADC 823 and DAC 843. The memory 851 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 851 may be, but not limited to, a single memory, CD, DVD, ROM, RAM, EEPROM, optical storage, or any other non-volatile or non-transitory storage medium capable of storing digital data.

An optionally incorporated SIM card 849 carries, for instance, important information, such as the cellular phone number, the carrier supplying service, subscription details, and security information. The SIM card 849 serves primarily to identify the mobile station 801 on a radio network. The card 849 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method for privacy-sensitive routing comprising:
receiving, by one or more processors, sensor data, path data, infrastructure data, usage data, or any combination thereof, indicating one or more obstructions to movement within an indoor space;
processing the sensor data, path data, infrastructure data, usage data, or any combination thereof, to compute a friction index for the indoor space based on a distribution of the one or more obstructions, wherein friction is impedance to movement caused by the one or more obstructions, and the friction index identifies one or more levels of friction, respectively, associated with one or more regions within the indoor space;
generating a navigation route based on the friction index, wherein at least a portion of the navigation route traverses at least a portion of the indoor space; and
providing the navigation route as an output.

2. The method of claim 1, wherein:
the received path data comprises one or more circumventing paths indicating the presence of one or more of the obstructions, and
the friction index is computed based at least on presence of the one or more obstructions indicated by the one or more circumventing paths.

3. The method of claim 1, wherein the path data is retrieved from one or more mobile devices and comprises historical path data.

4. The method of claim 1, wherein the infrastructure data comprises structural maps and dimensions of structural features associated with the indoor space.

5. The method of claim 1, wherein the usage data comprises occupancy levels for one or more of office spaces, living spaces, and parking spaces within the indoor space.

6. The method of claim 1, wherein the navigation route comprises:
a starting point and an ending point, from which a route of minimum duration and a route of minimum distance are calculated based on an absence of obstructions,
wherein at least a portion of the navigation route differs from the route of minimum duration or the route of minimum distance based on the portion being a greater distance from at least one region of the indoor space for which a level of friction was calculated than at least one of the route of minimum duration or the route of minimum distance.

7. The method of claim 1, further comprising:
identifying one or more attributes of the one or more obstructions producing friction; and
training a machine learning model using the one or more attributes and the one or more obstructions.

8. The method of claim 7, further comprising:
predicting a friction index for a second indoor space using the machine learning model.

9. The method of claim 1, wherein the one or more sensors are location-based within the indoor space, carried on mobile devices within the indoor space, or a combination thereof.

10. The method of claim 1, wherein the one or more sensors comprise one or more of a motion sensor, a radar sensor, infrared, an ultrasonic sensor, a vision-oriented sensor, such as digital video cameras, light detection and ranging (LIDAR) systems, a carbon-dioxide sensor, a carbon-monoxide sensor, a temperature sensor, a sound sensor, or a combination thereof.

11. The method of claim 10, further comprising:
processing the sensor data to determine one or more gradients of data collected from one or more of the carbon-dioxide sensor, the carbon-monoxide sensor, the temperature sensor, the sound sensor, or a combination thereof; and
determining the distribution of the one or more obstructions in the indoor space based at least on the one or more gradients.

12. The method of claim 1, wherein the one or more obstructions comprise one or more static map features, one or more dynamic elements, or a combination thereof.

13. An apparatus for privacy-sensitive routing comprising:
at least one processor; and
at least one memory including computer program code for one or more programs, the at least one memory and the computer program code configured to, with the at least one processor, cause the apparatus to:
receive, by one or more processors, sensor data, path data, infrastructure data, usage data, or any combination thereof, indicating one or more obstructions to movement within an indoor space;
process the sensor data, path data, infrastructure data, usage data, or any combination thereof, to compute a friction index for the indoor space based on a distribution of the one or more obstructions, wherein friction is impedance to movement caused by the one or more obstructions, and the friction index identifies one or more levels of friction, respectively, associated with one or more regions within the indoor space;
generate a navigation route based on the friction index, wherein at least a portion of the navigation route traverses at least a portion of the indoor space; and
provide the navigation route as an output.

14. The apparatus of claim 13, wherein:
the received path data comprises one or more circumventing paths indicating the presence of one or more of the obstructions, and
the friction index is computed based at least on presence of the one or more obstructions indicated by the one or more circumventing paths.

15. The apparatus of claim 13, wherein the apparatus if further caused to:
identify one or more attributes of the one or more obstructions producing friction; and
train a machine learning model using the one or more attributes and the one or more obstructions.

16. The apparatus of claim 15, wherein the apparatus if further caused to:
predict a friction index for a second indoor space using the machine learning model.

17. The apparatus of claim 13, wherein the apparatus if further caused to:
process the sensor data to determine one or more gradients of data collected from one or more of the carbon-dioxide sensor, the carbon-monoxide sensor, the temperature sensor, the sound sensor, or a combination thereof; and
determine the distribution of the one or more obstructions in the indoor space based at least on the one or more gradients.

18. A non-transitory computer-readable storage medium having stored thereon one or more program instructions which, when executed by one or more processors, cause an apparatus for privacy-sensitive routing to at least:
receive, by one or more processors, sensor data, path data, infrastructure data, usage data, or any combination thereof, indicating one or more obstructions to movement within an indoor space;
process the sensor data, path data, infrastructure data, usage data, or any combination thereof, to compute a friction index for the indoor space based on a distribution of the one or more obstructions, wherein friction is impedance to movement caused by the one or more obstructions, and the friction index identifies one or more levels of friction, respectively, associated with one or more regions within the indoor space;
generate a navigation route based on the friction index, wherein at least a portion of the navigation route traverses at least a portion of the indoor space; and
provide the navigation route as an output.

19. The non-transitory computer-readable storage medium of claim 13, wherein the apparatus if further caused to:
identify one or more attributes of the one or more obstructions producing friction; and
train a machine learning model using the one or more attributes and the one or more obstructions.

20. The non-transitory computer-readable storage medium of claim 19, wherein the apparatus if further caused to:
predict a friction index for a second indoor space using the machine learning model.
